(19) United States
(12) Patent Application Publication
(10) Pub. No.: US 2026/0208459 A1
(43) Pub. Date: Jul. 23, 2026

(54) VENTING UNIT, VULCANISATION MOULD, AND PNEUMATIC VEHICLE TYRE

(71) Applicant: Continental Reifen Deutschland GmbH, Hannover (DE)

(72) Inventors: Edwin Pang-Jian-Xiang, Bangsar, Kuala Lumpur (MY); Ruaidhri Gleeson, Hannover (DE); Nicholas Hoppe, Wunstorf (DE); Jürgen Dzick, Seelze (DE)

(73) Assignee: Continental Reifen Deutschland GmbH, Hannover (DE)

(21) Appl. No.: 19/142,307

(22) PCT Filed: Dec. 18, 2023
(86) PCT No.: PCT/DE2023/200263

§ 371 Date: Jun. 23, 2025

(30) Foreign Application Priority Data
Dec. 22, 2022 (DE) 10 2022 214 281.0

(51) Int. Cl. B29D 30/06

(52) U.S. Cl. CPC B29D 30/0606; B29D 2030/0617

(57) ABSTRACT

A venting unit for inserting into a hole which is made in a mold part of a vulcanizing mold for vulcanizing a green tire and extends from an inner side,
wherein the venting unit has a closed position and an open position and
a housing,
a valve insert,
valve disk, which belongs to the valve insert and, in the closed position of the venting unit, sits with a peripheral edge region against a seating surface which extends peripherally in the form of a ring around the outer end of the housing,
a valve stem, which belongs to the valve insert and has an outer, cylindrical stem portion, and
a helical compression spring.

This application is a National Stage Application under 35 U.S.C. § 371 of International Patent Application No. PCT/DE2023/200263 filed on Dec. 18, 2023, and claims priority from German Patent Application No. 10 2022 214 281.0 filed on Dec. 22, 2022, the disclosures of which are herein incorporated by reference in their entireties.

### BRIEF SUMMARY

The invention relates to a venting unit for inserting into a hole which is made in a mold part of a vulcanizing mold for vulcanizing a green tire and extends from an inner mold-part side,
wherein the venting unit has a closed position and an open position and comprises the following component parts:
a largely circular-cylindrical, sleeve-shaped housing, which can be pressed into the hole and has a largely constant inner diameter and a central axis,
a valve insert, which has been inserted into the housing and is movable with respect thereto in the axial direction,
a valve disk, which belongs to the valve insert, is circular in plan view and, in the closed position of the venting unit, sits with a peripheral edge region of a constant thickness flat against a seating surface which extends peripherally in the form of a ring around the outer end of the housing and is oriented at right angles to the central axis,
a valve stem, which belongs to the valve insert, adjoins the valve disk and has an outer, cylindrical stem portion, an inner stem portion and a transitional portion between these stem portions,
a helical compression spring, which surrounds the inner stem portion and the transitional portion of the valve stem and is supported by its one end on the housing and acts with its other end on the outer stem portion of the valve stem.

The invention also relates to a vulcanizing mold having at least one mold part with venting holes and to a pneumatic vehicle tire which has been vulcanized in the vulcanizing mold.

To provide venting of a tire vulcanizing mold during the molding of the green tire, a multiplicity of venting holes in which a venting unit is respectively incorporated are provided in mold parts, in particular in mold segments, which shape the tread region. Such venting units have valve inserts with valve closures, for example valve disks, which, when the green tire has been molded, close the venting holes and at least largely prevent the occurrence of rubber flash during the vulcanization of the tire. During the molding of the green tire, the venting inserts or their valve closures are open and protrude from the inner sides of the mold parts, for instance the mold segments, such that the required venting during the molding of the green tire is ensured.

A venting unit of the type mentioned at the beginning is known for example from WO 2020/211995 A1. The valve closure is stepped on the outside in the manner of a staircase and, in the closed position of the venting unit, is supported on a correspondingly stepped inner wall portion of the housing. The dimensioning and design of the steps is such that, in the closed position of the venting unit, a gap which extends peripherally in the form of a ring and has a width of 0.01 mm to 0.50 mm remains in each case between the corresponding step surfaces on the valve closure and those on the inner wall portion of the housing. All of the gaps are connected to one another and thereby form a single continuous, staircase-shaped gap which extends from the contact surfaces into the interior of the venting unit and changes direction in accordance with the number of steps. The gaps mentioned act as labyrinth gaps and therefore in a known way as a barrier against penetration and ingress of liquid or low-viscosity media, in particular particularly flowable rubber compounds, into the interior of the venting unit. Even when the venting unit is closed, the valve closure projects slightly beyond the inner mold-part side, wherein the projection is of the order of 0.05 mm to 0.20 mm and is conducive to good closing of the venting unit and the buildup of a counterpressure in the gaps.

A further venting unit for a vulcanizing mold of a pneumatic vehicle tire is known from WO 2017/211517 A1. This venting unit has a valve stem, with a frustoconical, outwardly widening valve disk, which lies against a counter-formed widening on the outer inner wall portion of the housing when the venting unit is closed. Adjoining the valve disk, the valve stem has a cylindrical holding portion, on which a helical compression spring, which presses the valve stem and thus the valve disk into the open position, can be fitted by at least two of its turns. This measure allows exact positioning and a good fit of the helical compression spring on the valve stem.

The unwanted ingress of particularly flowable modern rubber compounds for high-performance tires into venting units due to additional heating during the molding of tires continues to be a problem that has not been satisfactorily solved.

These particular rubber compounds leave behind visible traces of flash of various shapes and sizes around the venting units. Moreover, in the case of the known venting units it is scarcely avoidable after a certain number of heating cycles that rubber compounds which have ingressed into the interior of the venting units because of their flowability cause the venting units to fill with rubber material and to block the venting units, in particular the helical compression springs. As a result, sufficient venting of the vulcanizing mold is no longer ensured and shrinkage points occur on the vulcanized tire, affecting the quality of the vulcanized tires, even to the extent that they have to be rejected. The vulcanizing molds affected must be disassembled from the tire heating press and the venting units removed and replaced by new ones. These measures necessitate a standstill in production, and therefore additional costs, the latter also due to the requirement to install new venting units.

The invention is based on the object of improving a venting unit of the type mentioned at the beginning in such a way that the occurrence of flash is reliably avoided and that it ensures flawless venting over a much greater number of heating cycles than the known venting units, in particular by ingress of rubber compound being made more difficult and satisfactory functioning of the helical compression spring being ensured over a great number of heating cycles.

The stated object is achieved according to the invention by the outer edge region of the valve disk which in the closed position of the venting unit sits on the seating surface having a thickness of 0.10 mm to 0.40 mm, in particular of 0.20 mm to 0.25 mm, wherein the venting unit can be pressed into the hole in such a way that the seating surface extending peripherally around the outer end of the housing is inwardly offset with respect to the inner mold-part side by a distance of 0.05 mm to 0.35 mm, in particular of 0.10 mm to 0.15 mm, and wherein the radially outer stem portion of the valve stem has an outer diameter which is 80% to 97% of the inner diameter of the housing.

According to the invention, these measures in combination with one another provide that, even in the case of particularly flowable rubber compounds in the warm and unvulcanized state, satisfactory functioning of the venting unit is ensured over a much greater number of heating cycles than in the case of the known venting units. Due to a corresponding adaptation of the distance between the seating surface on the housing and the inner side of the mold with the thickness of the edge of the valve disk resting there in the closed position, the movement path during the opening and closing is very small and, when the venting unit is closed, the valve disk at most projects slightly beyond the inner mold-part side, whereby on the one hand the closing of the venting unit is optimally assisted during the molding of the green tire and on the other hand the narrow gap that is present when the venting unit is open scarcely leaves room for any ingress of rubber material. Any ingressing rubber material is also hindered from advancing in the still flowable state into the sensitive area of the helical compression spring by the likewise only narrow gap between the radially outer stem portion of the valve stem and the inner wall of the housing.

Particularly preferred is a design in which the radially outer stem portion of the valve stem has an outer diameter which is 85% to 90% of the inner diameter of the housing.

In the case of a particularly preferred embodiment, the radially outer stem portion of the valve stem has such a length of extent that the helical compression spring acts on this portion at a position which is located at a distance, taken from the outer end of the venting unit, of 30% to 60% of the overall length of the venting unit. This measure is also conducive to the effect that any ingressing rubber compound or ingressing rubber material does not advance into the area of the helical compression spring.

Advantageously, furthermore, the seating surface extending peripherally around the outer end of the housing is the outer free edge of the housing, so that, when a venting unit has been pressed into a hole, outside the seating surface there is only a portion of the wall of the hole reaching up to the inner side of the mold part.

This portion of the wall of the hole has in particular a height, determined in the direction of extent of the hole, of 0.10 mm to 0.15 mm. The venting unit is therefore pressed only a little way into the interior of the hole, without the risk of damage to the housing.

An optimum seating of the valve disk on the seating surface of the housing is assisted in particular by the outer edge region of the valve disk having a width of 0.20 mm to 0.30 mm and overlapping with the seating surface on the outer edge of the housing in such a way that, when the venting unit is closed, a gap with a width of 0.04 mm to 0.06 mm remains between the edge of the edge region of the valve disk and the portion of the wall of the hole.

An optimum seating of the valve disk on the seating surface of the housing along with good movability of the same is also preferably ensured by the seating surface which extends peripherally around the end of the housing on the inner side of the mold part extending around the outside of an opening in the housing which outwardly widens in a funnel-shaped manner and is formed by a continuous decrease in the wall thickness of the housing, so that the supporting surface has a width of 0.20 mm to 0.35 mm.

The movability and stability of the valve disk are also assisted by the latter having a disk base part which reaches with a frustoconical portion of decreasing diameter up to the adjoining outer stem portion, wherein this frustoconical portion has parallel to the central axis a thickness of 0.25 mm to 0.40 mm and the smallest diameter of the frustoconical portion is after the outer stem portion and is 0.20 mm to 0.40 mm greater than the diameter of the outer stem portion.

For durable functioning of the helical compression spring, according to a further configuration it is advantageous if on the outer stem portion of the valve stem there is formed at the transitional portion a supporting surface which extends peripherally in the form of a ring, on which the helical compression spring is supported and in such a way presses the valve stem and thus the valve disk into the open position.

The vulcanizing mold according to the invention has at least one mold part with venting holes in which venting units. The mold parts are mold segments which form a segment ring for the shaping of the tread of the pneumatic vehicle tire. Such a vulcanizing mold can be used to vulcanize tires with treads produced from a rubber compound which is supersoft and therefore particularly flowable in the warm and unvulcanized state over a great number of heating cycles without significant flash occurring on the tread.

The pneumatic vehicle tire according to the invention has been vulcanized in a vulcanizing mold.

### BRIEF DESCRIPTION OF THE SEVEREAL VIEWS OF THE DRAWINGS

Further features, advantages and details of the invention are now described more specifically on the basis of the drawing, which represents an exemplary embodiment and in which:

FIG. 1 shows an enlarged view, partly cut open, of a venting unit in the closed state,

FIG. 2 shows an enlarged sectional representation (longitudinal section) of a housing of the venting unit inserted in a mold part and

FIG. 3 shows an enlarged view of a valve stem.

### DETAILED DESCRIPTION

FIG. 2 shows a sectional representation of a housing 6 of a venting unit 3 inserted in a hole 2 made in a mold part 1, for instance a mold segment, of a vulcanizing mold for a pneumatic vehicle tire. The mold part 1 has an inner mold-part side 1a, facing the mold cavity, and an outer mold-part side, not shown. Usually, a number of mold segments form a mold segment ring for the shaping of a profiled tread of a green tire that has been inserted into the vulcanizing mold.

In the following description of an exemplary embodiment of a venting unit 3, the configuration and arrangement of its component parts are considered with reference to their installation position in a mold part 1, for instance a mold segment of a segment ring shaping the tread, with designations such as “outer”, “outer side”, “outside” and the like relating to positions on or near that of the inner mold-part side 1a, and designations such as inner, inside, inner side and the like relating to positions further in the interior of the mold part 1 or of the venting unit 3.

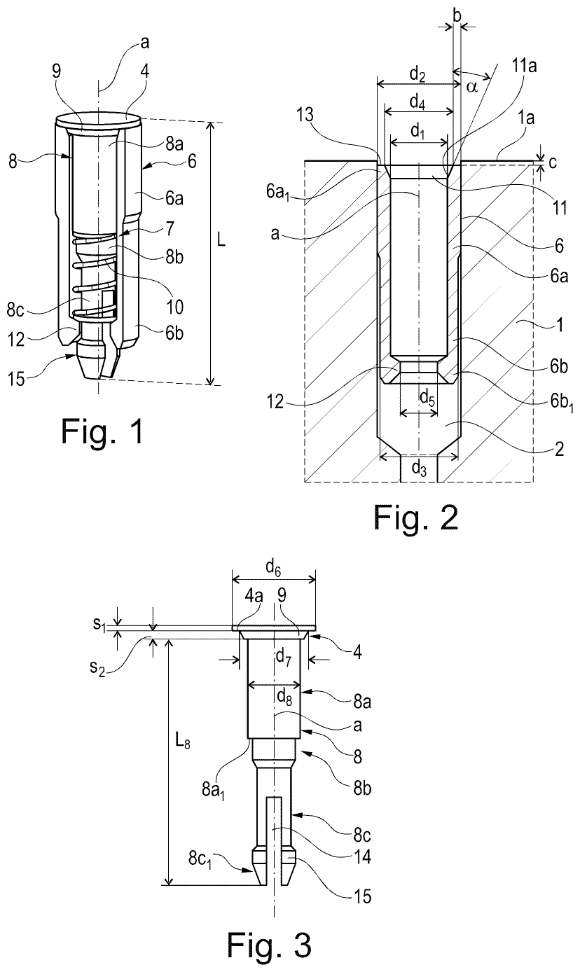

As FIG. 1 in particular shows, the main component parts of each venting unit 3 are the elongated housing 6 and a likewise elongated valve insert 7 inserted in the housing 6. The housing 6 is a largely cylindrical component with a central axis a. The valve insert 7 has a valve stem 8, the valve disk 4, which sits on it on the outer side and has a disk base part 9, and also a helical compression spring 10. The central axis a is also the central longitudinal axis of the valve insert 7, which is of a largely rotationally symmetrical design. In the open position of the venting unit 3, at least the upper side of the valve disk 4 protrudes beyond the inner mold-part side 1a in such a way that air can enter the venting unit 3 and be led away. A green tire molded into the vulcanizing mold presses the valve disk 4 into its closed position.

The housing 6 which is represented in FIG. 2 and is of a sleeve-shaped and rotationally symmetrical design with respect to the axis a has an outer housing portion 6a with a specially designed end portion 6a₁ and an inner housing portion 6b with a specially designed end portion 6b₁. Between the two end portions 6a₁, 6b₁, the housing portions 6 a and 6 b have an equally large, constant inner diameter d₁ of 1.60 mm to 2.20 mm. The outer housing portion 6a has a constant outer diameter d₂, the inner housing portion 6b has a constant outer diameter d₃, wherein the outer diameter d₂ is greater by 0.10 mm to 0.40 mm, preferably 0.15 mm to 0.30 mm, than the outer diameter d₃, so that the wall thickness of the housing 6 in the outer housing portion 6a is greater than the wall thickness of the housing 6 in the inner housing portion 6b.

In the end portion 6a₁, which, when considered parallel to the axis a, extends over 0.40 mm to 0.50 mm, there is formed by a continuous decrease in the wall thickness of the housing 6 and by a continuous increase in the inner diameter an opening 11 which outwardly widens in a funnel-shaped manner and peripherally around which there extends a sloping surface 11a, which extends with respect to the central axis a at a constant angle a of 20° to 24°. Extending peripherally around the opening 11 on the outer side is a ring-shaped, planar seating surface 13, which is oriented at right angles to the axis a and has a constant width b of 0.20 to 0.35 mm and an inner diameter d₄ of 1.90 mm to 2.70 mm. The seating surface 13 forms the outer free edge of the housing 6.

In the end portion 6b₁ of the inner housing portion 6b there is formed on the inner wall a projection 12 which extends peripherally around the latter and leaves a circular opening which has a diameter ds, which is less by 0.50 mm to 0.80 mm than the inner diameter d₁ of the housing 6.

A press fit has the effect that the venting unit 3 sits in the venting hole 2 of the mold segment 1 in such a way that the seating surface 13 extending peripherally in the form of a ring around the outside of the housing 6 is located within the inner mold-part side 1a inwardly offset with respect thereto by a distance c of 0.05 mm to 0.35 mm, in particular 0.10 mm to 0.15 mm. In the closed position of the venting unit 3, the valve disk 4 comes to bear against the seating surface 13 extending peripherally in the form of a ring.

As FIG. 3 in particular shows, the valve disk 4, which is circular in plan view, has on its outer side a diameter de, which is greater by 0.30 mm to 0.60 mm than the inner diameter d₄ of the seating surface 13, and an edge region 4a, which extends peripherally around the disk base part 9 and has a constant thickness s₁ of 0.10 mm to 0.40 mm, in particular of 0.20 mm to 0.25 mm, and a constant width of 0.20 to 0.30 mm. With respect to the wall of the venting hole 3 there remains a narrow peripheral gap with a width of approximately 0.04 mm to 0.06 mm. It is thereby ensured that, in the closed position of the venting unit 3, the valve disk 4 rests with its edge flat against the seating surface 13. As a result of its thickness s₁, the valve disk 4 in this position protrudes beyond the inner mold-part side 1a by around 0.10 mm. The disk base part 9 has a frustoconical portion, which has a diameter decreasing in the direction of the interior of the housing 6 with a greatest diameter d₇, which is smaller by 0.40 mm to 0.60 mm than the diameter de on the outer side of the valve disk 4, and a thickness s₂ of 0.25 mm to 0.40 mm. The inclination of the outer surface of the disk base part 9 that there is in relation to the central axis a is chosen in such a way that, in the closed position of the venting unit 3, the disk base part 9 does not come into contact with the inner wall of the housing 6.

The disk base part 9 is adjoined by the valve stem 8 with a cylindrical outer stem portion 8a, which is followed by a transitional portion 8b, and the latter is followed by an inner stem portion 8c with an end portion 8c₁. The outer stem portion 8 a has an outer diameter d₈, which is 80% to 97%, in particular 85% to 90%, of the inner diameter d₁ of the housing 6. The outer stem portion 8a has a minimum length of 2.50 mm and preferably extends over 30% to 50%, in particular 38% to 43%, of the overall length L₈ of the valve stem 8. The valve stem 8 has its greatest diameter in the outer stem portion 8a, its smallest diameter in the inner stem portion 8c. The transitional portion 8b has a diameter which is less than the diameter in the outer stem portion 8a and greater than the diameter in the inner stem portion 8c in such a way that on the outer stem portion 8a there remains with respect to the transitional portion 8b a supporting surface 8a₁ which extends peripherally in the form of a ring, on which the one end of the helical compression spring 10 which is positioned around the inner stem portion 8c and around the transitional portion 8b is supported. The outer stem portion 8a is preferably designed with such a length of extent that the helical compression spring 10 acts on this portion at a position which is located at a distance, taken from the outer end of the venting unit 3, of 30% to 60% of the overall length L (FIG. 1) of the venting unit 3.

In the inner stem portion 8c and extending over the end portion 8c₁, a slit 14 is formed along the central axis a. The end portion 8c₁ divided in two by the slit 14 has a respective projection 15 on the outer side, so that when the valve stem 8 is inserted into the housing 6 the projections 15 engage under the projection 12 extending peripherally around the inner end of the housing 6. The helical compression spring 10 positioned on the inner stem portion 8c is supported by its second end on the inner side of the housing on the peripheral projection 12.

### LIST OF REFERENCE SIGNS

1 Mold part
2 Venting hole
1a Inner mold-part side
3 Venting unit
4 Valve disk
4a Edge region
5 Tread
6 Housing
6a Outer housing portion
6b Inner housing portion
6a₁, 6b₁ End portion
7 Valve insert
8 Valve stem
8a Outer stem portion
8a Supporting surface
8b Transitional portion
8c Inner stem portion
8c End portion
9 Disk base part
10 Helical compression spring
11 Opening
11a Sloping surface
12 Projection
13 Seating surface extending peripherally in the form of a ring
14 Slit
15 Projection
a Central axis
α Angle (sloping surface 11a)
d₁ Inner diameter of the housing 6
d₂ Outer diameter of the outer housing portion 6a
d₃ Outer diameter of the inner housing portion 6b
d₄ Inner diameter of the seating surface 13
d₅ Diameter of the opening at the projection 12
d₆ Diameter of the valve disk 4
d₇ Greatest diameter of the frustoconical portion of the disk base part 9
d₈ Outer diameter of the stem portion 8a
s₁ Thickness of the valve disk 4
s₂ Thickness of the frustoconical portion of the disk base part
b Width of the seating surface 13
L Overall length of the venting unit 3
L₈ Overall length of the valve stem 8
C Distance

1. A venting unit for inserting into a hole which is made in a mold part of a vulcanizing mold for vulcanizing a green tire and extends from an inner side,
wherein the venting unit has a closed position and an open position and comprises the following component parts:
a largely circular-cylindrical, sleeve-shaped housing, which can be pressed into the hole and has a largely constant inner diameter and a central axis,
a valve insert, which has been inserted into the housing and is movable with respect thereto in the axial direction,
a valve disk, which belongs to the valve insert, is circular in plan view and, in the closed position of the venting unit, sits with a peripheral edge region of a constant thickness flat against a seating surface which extends peripherally in the form of a ring around the outer end of the housing and is oriented at right angles to the central axis and such that it remains within the seating surface,
a valve stem, which belongs to the valve insert, adjoins the valve disk and has an outer, cylindrical stem portion, an inner stem portion and a transitional portion between these stem portions,
a helical compression spring, which surrounds the inner stem portion and the transitional portion of the valve stem and is supported by its one end on the housing and acts with its other end on the outer stem portion of the valve stem,
wherein the outer edge region of the valve disk which in the closed position of the venting unit sits on the seating surface has a thickness of 0.10 mm to 0.40 mm, wherein the venting unit can be pressed into the hole that the seating surface extending peripherally around the outer end of the housing is inwardly offset with respect to the inner mold-part side by a distance of 0.05 mm to 0.35 mm, and wherein the radially outer stem portion of the valve stem has an outer diameter which is 80% to 97% of the inner diameter of the housing.

2. The venting unit as claimed in claim 1, wherein the radially outer stem portion of the valve stem has an outer diameter which is 85% to 90% of the inner diameter of the housing.

3. The venting unit as claimed in claim 1, wherein the radially outer stem portion of the valve stem has such a length of extent that the helical compression spring acts on this portion at a position which is located at a distance, taken from the outer end of the venting unit, of 30% to 60% of the overall length of the venting unit.

4. The venting unit as claimed in claim 1, wherein that the seating surface extending peripherally around the outer end of the housing is the outer free edge of the housing, so that, when a venting unit has been pressed into a hole, outside the seating surface there is a portion of the wall of the hole reaching up to the inner side of the mold part.

5. The venting unit as claimed in claim 1, wherein the outer edge region of the valve disk has a width of 0.20 mm to 0.30 mm and overlaps with the seating surface on the outer edge of the housing in such a way that, when the venting unit is closed, a gap with a width of 0.04 mm to 0.06 mm remains between the edge of the edge region of the valve disk and the portion of the wall of the hole.

6. The venting unit as claimed in claim 1, wherein the seating surface which extends peripherally around the end of the housing on the inner side of the mold part extends around the outside of an opening in the housing which outwardly widens in a funnel-shaped manner and is formed by a continuous decrease in the wall thickness of the housing, so that the supporting surface has a width of 0.20 mm to 0.35 mm.

7. The venting unit as claimed in claim 1, wherein the valve disk has a disk base part which reaches with a frustoconical portion of decreasing diameter up to the adjoining outer stem portion, wherein this frustoconical portion has parallel to the central axis a thickness of 0.25 mm to 0.40 mm and its smallest diameter is after the outer stem portion and is 0.20 mm to 0.40 mm greater than the diameter of the outer stem portion.

8. The venting unit as claimed in claim 1, wherein on the outer stem portion of the valve stem there is formed at the transitional portion a supporting surface which extends peripherally in the form of a ring, on which the helical compression spring is supported.

9. A vulcanizing mold for a pneumatic vehicle tire having:
at least one mold part with venting holes in which at least one venting units have been inserted;
wherein the venting unit has a closed position and an open position and comprises the following component parts:
a largely circular-cylindrical, sleeve-shaped housing, which can be pressed into the hole and has a largely constant inner diameter and a central axis,
a valve insert, which has been inserted into the housing and is movable with respect thereto in the axial direction,
a valve disk, which belongs to the valve insert, is circular in plan view and, in the closed position of the venting unit, sits with a peripheral edge region of a constant thickness flat against a seating surface which extends peripherally in the form of a ring around the outer end of the housing and is oriented at right angles to the central axis and such that it remains within the seating surface,
a valve stem, which belongs to the valve insert, adjoins the valve disk and has an outer, cylindrical stem portion, an inner stem portion and a transitional portion between these stem portions,
a helical compression spring, which surrounds the inner stem portion and the transitional portion of the valve stem and is supported by its one end on the housing and acts with its other end on the outer stem portion of the valve stem,
wherein the outer edge region of the valve disk which in the closed position of the venting unit sits on the seating surface has a thickness of 0.10 mm to 0.40 mm, wherein the venting unit can be pressed into the hole that the seating surface extending peripherally around the outer end of the housing is inwardly offset with respect to the inner mold-part side by a distance of 0.05 mm to 0.35 mm and wherein the radially outer stem portion of the valve stem has an outer diameter which is 80% to 97% of the inner diameter of the housing.

10. The vulcanizing mold as claimed in claim 9, in which the mold parts are mold segments which form a segment ring for the shaping of the tread of the pneumatic vehicle tire.

11. A vehicle pneumatic tire comprising:
a tire which has been vulcanized in a vulcanizing mold;
the vulcanizing mold having at least one mold part having a venting unit:
wherein the venting unit has a closed position and an open position and comprises the following component parts:
a largely circular-cylindrical, sleeve-shaped housing, which can be pressed into the hole and has a largely constant inner diameter and a central axis,
a valve insert, which has been inserted into the housing and is movable with respect thereto in the axial direction,
a valve disk, which belongs to the valve insert, is circular in plan view and, in the closed position of the venting unit, sits with a peripheral edge region of a constant thickness flat against a seating surface which extends peripherally in the form of a ring around the outer end of the housing and is oriented at right angles to the central axis and such that it remains within the seating surface.
a valve stem, which belongs to the valve insert, adjoins the valve disk and has an outer, cylindrical stem portion, an inner stem portion and a transitional portion between these stem portions,
a helical compression spring, which surrounds the inner stem portion and the transitional portion of the valve stem and is supported by its one end on the housing and acts with its other end on the outer stem portion of the valve stem,
wherein the outer edge region of the valve disk which in the closed position of the venting unit sits on the seating surface has a thickness of 0.10 mm to 0.40 mm, wherein the venting unit can be pressed into the hole that the seating surface extending peripherally around the outer end of the housing is inwardly offset with respect to the inner mold-part side by a distance of 0.05 mm to 0.35 mm and wherein the radially outer stem portion of the valve stem has an outer diameter which is 80% to 97% of the inner diameter of the housing.

12. A venting unit for a vulcanizing mold for a green tire, the venting unit comprising:
a closed position and an open position;
a largely circular-cylindrical, sleeve-shaped housing, which can be pressed into the hole and has a largely constant inner diameter and a central axis;
a valve insert, which has been inserted into a housing and is movable with respect thereto in the axial direction;
a valve disk that is circular in plan view and, in the closed position of the venting unit, sits with a peripheral edge region of a constant thickness flat against a seating surface which extends peripherally in the form of a ring around the outer end of the housing and is oriented at right angles to the central axis and such that it remains within the seating surface;
a valve stem, which belongs to the valve insert, adjoins the valve disk and has an outer, cylindrical stem portion, an inner stem portion and a transitional portion between these stem portions;
a helical compression spring, which surrounds the inner stem portion and the transitional portion of the valve stem and is supported by its one end on the housing and acts with its other end on the outer stem portion of the valve stem;
wherein the outer edge region of the valve disk which in the closed position of the venting unit sits on the seating surface has a thickness of 0.10 mm to 0.40 mm;
wherein the venting unit can be pressed into the hole that the seating surface extending peripherally around the outer end of the housing is inwardly offset with respect to the inner mold-part side by a distance of 0.05 mm to 0.35 mm;
wherein the radially outer stem portion of the valve stem has an outer diameter which is 85% to 90% of the inner diameter of the housing;
wherein the radially outer stem portion of the valve stem has a length of extent that the helical compression spring acts on this portion at a position which is located at a distance, taken from the outer end of the venting unit, of 30% to 60% of the overall length of the venting unit;
wherein that the seating surface extending peripherally around the outer end of the housing is the outer free edge of the housing, so that, when a venting unit has been pressed into a hole, outside the seating surface there is a portion of the wall of the hole reaching up to the inner side of the mold part;
wherein the outer edge region of the valve disk has a width of 0.20 mm to 0.30 mm and overlaps with the seating surface on the outer edge of the housing in such a way that, when the venting unit is closed, a gap with a width of 0.04 mm to 0.06 mm remains between the edge of the edge region of the valve disk and the portion of the wall of the hole;
wherein the seating surface which extends peripherally around the end of the housing on the inner side of the mold part extends around the outside of an opening in the housing which outwardly widens in a funnel-shaped manner and is formed by a continuous decrease in the wall thickness of the housing, so that the supporting surface has a width of 0.20 mm to 0.35 mm;
wherein the valve disk has a disk base part which reaches with a frustoconical portion of decreasing diameter up to the adjoining outer stem portion, wherein this frustoconical portion has parallel to the central axis a thickness of 0.25 mm to 0.40 mm and its smallest diameter is after the outer stem portion and is 0.20 mm to 0.40 mm greater than the diameter of the outer stem portion; and
wherein on the outer stem portion of the valve stem there is formed at the transitional portion a supporting surface which extends peripherally in the form of a ring, on which the helical compression spring is supported.

13. The venting unit of claim 12, wherein the venting unit is within a mold segment of a segment ring for shaping of tread of a pneumatic vehicle tire.

14. The venting unit of claim 13, wherein the pneumatic vehicle tire is vulcanized with the segment ring.

15. A method of vulcanizing a tire with a mold, the method comprising:
providing a green tire;
providing a mold having a plurality of mold segments that form a segment ring;
inserting a venting unit into a hole of a mold part of the plurality of mold segments, the venting unit having an open position and a closed position;
wherein the venting unit has an outer edge region of a valve disk that sits on a seating surface that extends peripherally around an outer end of the housing when the venting unit is in the closed position; and
initiating vulcanizing the green tire with the venting unit in the open position;
transitioning the venting unit to the closed position when the green tire has been molded; and
forming a pneumatic tire.

16. The method of claim 15, further comprising mitigating occurrence of flash by the venting unit.

17. The method of claim 15, further comprising providing helical compression by the helical compression spring.
